(19) United States
(12) Patent Application Publication
(10) Pub. No.: US 2025/0001880 A1
(43) Pub. Date: Jan. 2, 2025

(54) Load-bearing battery structures and the use of such structures in an aircraft

(71) Applicant: Evgeny Forshter, Sarasota, FL (US)

(72) Inventor: Evgeny Forshter, Sarasota, FL (US)

(21) Appl. No.: 18/343,738

(22) Filed: Jun. 28, 2023

(51) Int. Cl. B60L 50/64; B64D 27/24; H01M 50/264

(52) U.S. Cl. CPC B60L 50/64; B64D 27/24; H01M 50/264; B60L 2200/10; H01M 2220/20

(57) ABSTRACT

A mechanical load-bearing structure, comprised of electrochemical cells connected between each other and to other structures and elements with mechanical load-bearing links, where the cells transfer the mechanical load or a portion of the mechanical load and an aircraft comprising such structures

### FIELD OF THE INVENTION

The present invention relates in general to the field of airspace design, and more particularly, to the load-bearing energy storage structures.

### BACKGROUND OF THE INVENTION

An aircraft's weight need to be minimized in order to increase flight time, distance, and payload. This is particularly important for electric aircraft due to the low energy density of existing energy storage elements.

Therefore, a need exists to improve the stored energy content to mass ratio for an aircraft.

### BRIEF SUMMARY OF THE INVENTION

An exemplary load-bearing battery of the present invention comprised of electrochemical cells connected with load-bearing links to form a load-bearing structure.

In various embodiments of this exemplary load-bearing battery, in areas between the links, the cells may be the only load-bearing elements or may have additional load-bearing elements.

A suitable cell for the exemplary battery comprises the 18650 cell format, but other cylindrical and non-cylindrical cells can be employed.

In various embodiments of the present invention, the load-bearing links between battery cells may be conductive, or non-conductive. The conductive load-bearing links may be used to connect the cells parallel or in series or provide an electrical connection to the battery or individual cells.

Another exemplary aircraft of the present invention may use the load-bearing battery as a load-bearing element of a wing.

In various embodiments of the present invention, a motor connector is used to mount a multirotor aircraft motor on the battery.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is a perspective view of a multirotor aircraft comprising load-bearing battery.

FIG. 2 is a perspective view of a load-bearing battery.

FIG. 3 is a perspective view of a load-bearing battery.

FIG. 3A is a side view of a load-bearing battery.

FIG. 3B is a cutaway view of a load-bearing battery.

FIG. 3C is a cutaway view of a load-bearing battery.

FIG. 4 is a perspective view of a load-bearing battery.

FIG. 4A is a side view of a load-bearing battery.

FIG. 4B is a cutaway view of a load-bearing battery.

FIG. 4C is a cutaway view of a load-bearing battery.

FIG. 5 is a perspective view of a load-bearing battery.

FIG. 5A is a side view of a load-bearing battery.

FIG. 5B is a cutaway view of a load-bearing battery.

FIG. 5C is a cutaway view of a load-bearing battery.

FIG. 6 is a perspective view of a load-bearing battery.

FIG. 6A is a side view of a load-bearing battery.

FIG. 6B is a cutaway view of a load-bearing battery.

FIG. 6C is a cutaway view of a load-bearing battery.

FIG. 7 is a perspective view of a load-bearing battery.

FIG. 8 is a perspective view of a load-bearing battery.

FIG. 9 is a perspective view of a load-bearing battery.

FIG. 9A is a side view of a load-bearing battery.

FIG. 9B is a cutaway view of a load-bearing battery.

FIG. 10 is a perspective view of a load-bearing battery.

FIG. 10A is a side view of a load-bearing battery.

FIG. 10B is a cutaway view of a load-bearing battery.

FIG. 11 is a side view of a load-bearing battery.

FIG. 12 is a perspective view of a wing comprising a load-bearing battery

FIG. 13 is a perspective view of a wing comprising a load-bearing battery with multirotor motor mounts

### DETAILED DESCRIPTION OF THE INVENTION

The terminology used herein is for the purpose of describing particular embodiments only and is not intended to be limiting the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Load-bearing battery structures and the use of such structures in aircrafts are discussed herein. In the following description, for purposes of explanation, numerous specific details are set forth in order to provide a thorough understanding of the present invention. It will be evident, however, to one skilled in the art that the present invention may be practiced without this specific detail.

The present disclosure is to be considered as an exemplification of the invention and is not intended to limit the invention to the specific embodiments illustrated by the figures or description below.

The present invention will now be described by referencing the appended figures representing the preferred embodiment.

The present invention comprises a design of load-bearing battery structures and the use of such structures in aircrafts.

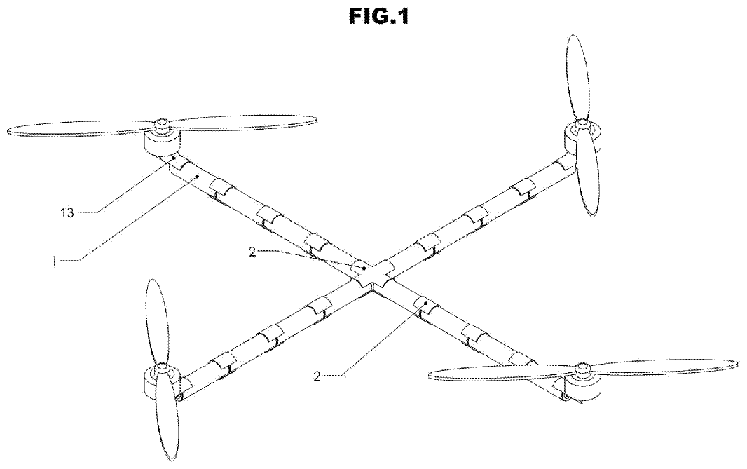

The mechanical load-bearing battery structure, as seen in FIG. 1 comprised of electrochemical cells (1) connected between each other and to other structures and elements with mechanical load-bearing links (2). The links transmit loads between the cells and between the cells and other structures and elements. A suitable cell for the exemplary structure comprises the 18650 cells format, but other cylindrical and non-cylindrical cells can be employed. The cells transmit mechanical loads between links, the cells may transmit the whole mechanical load or a part of the load.

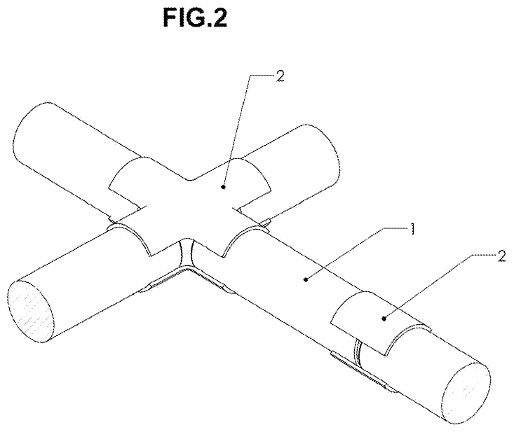

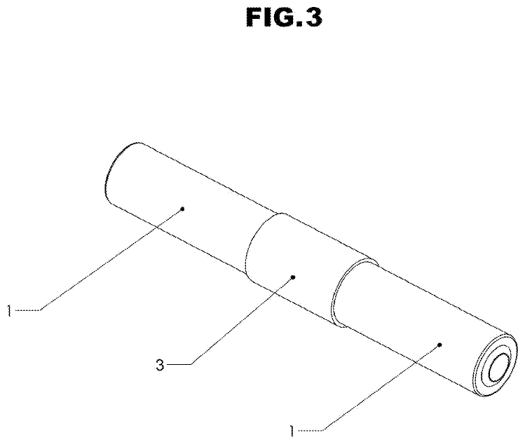

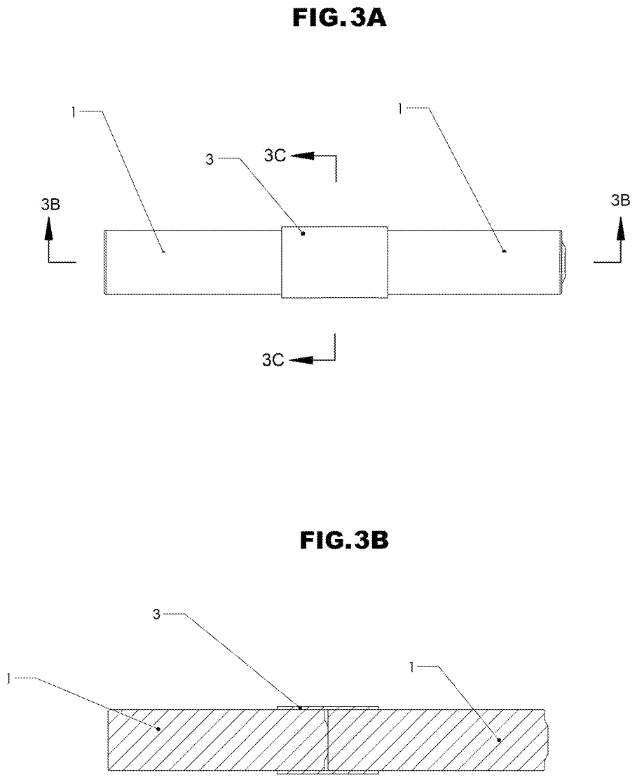

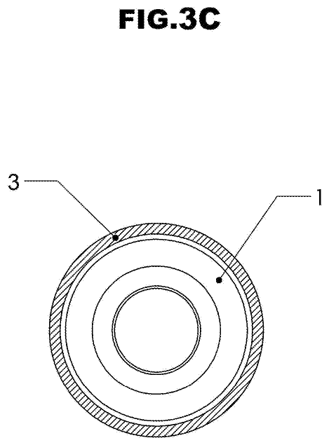

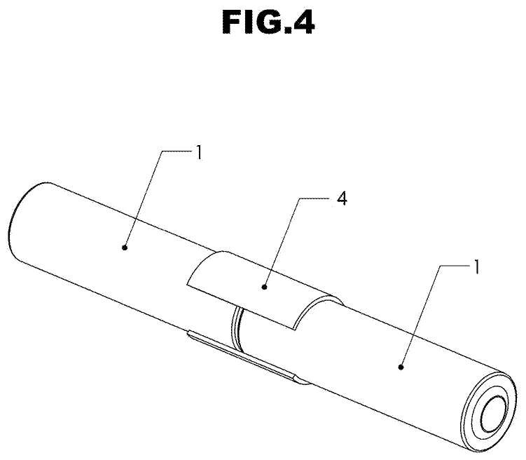

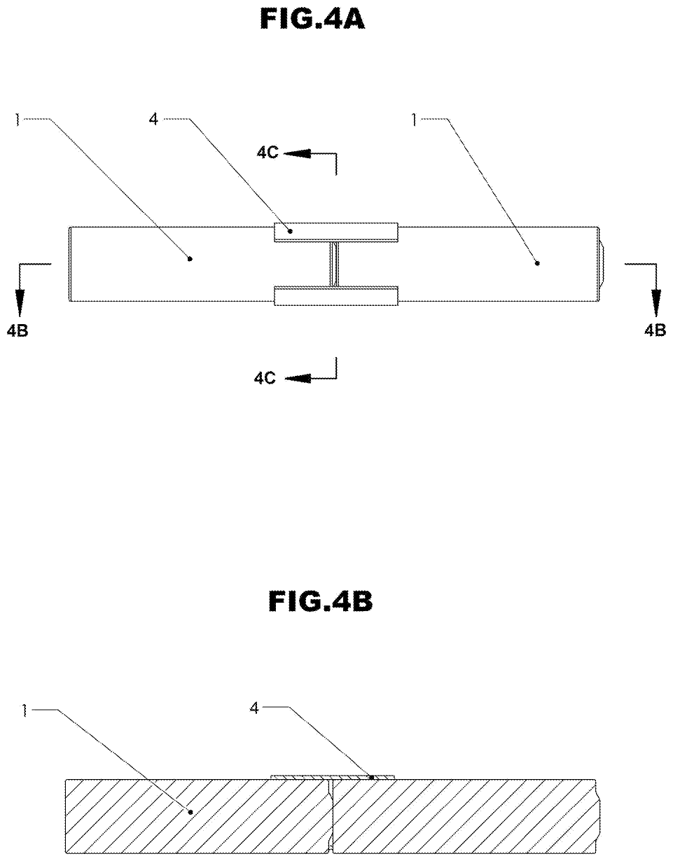

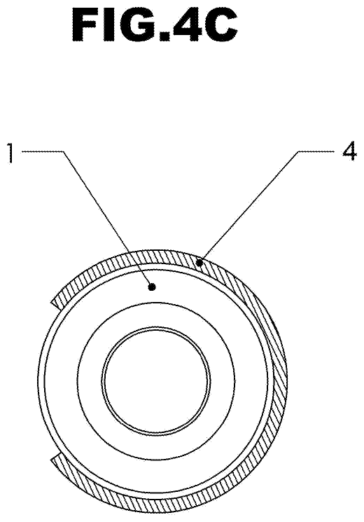

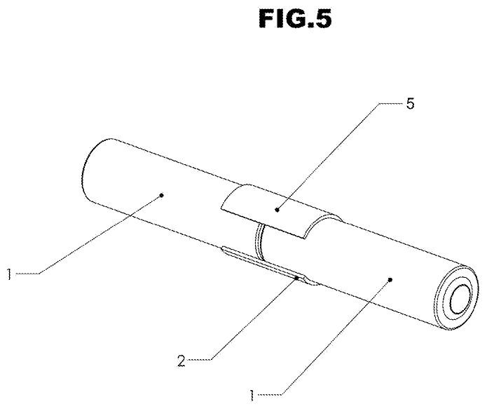

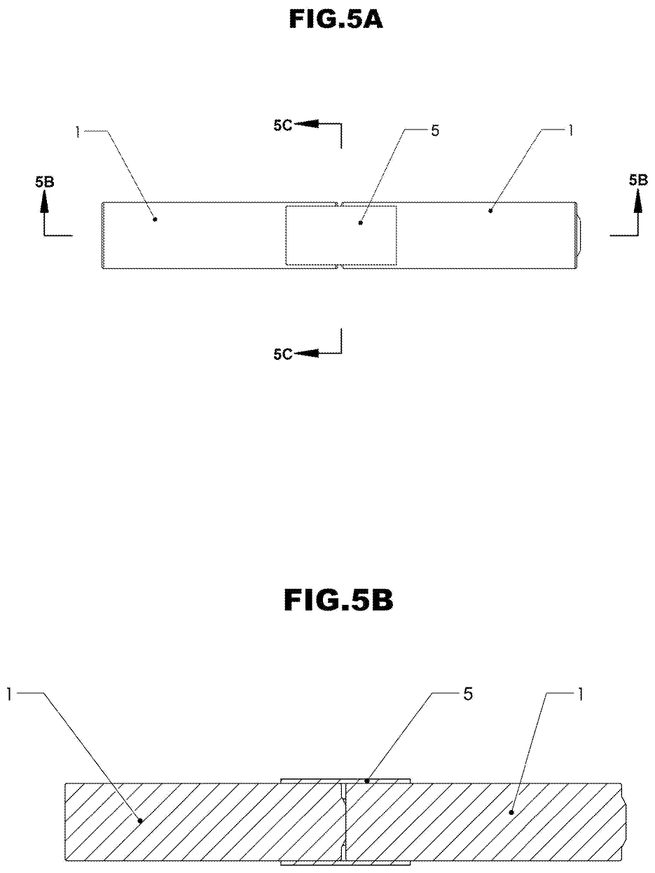

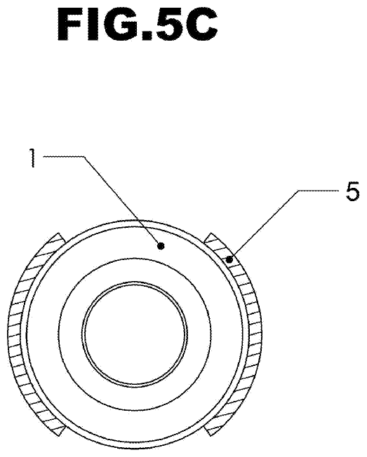

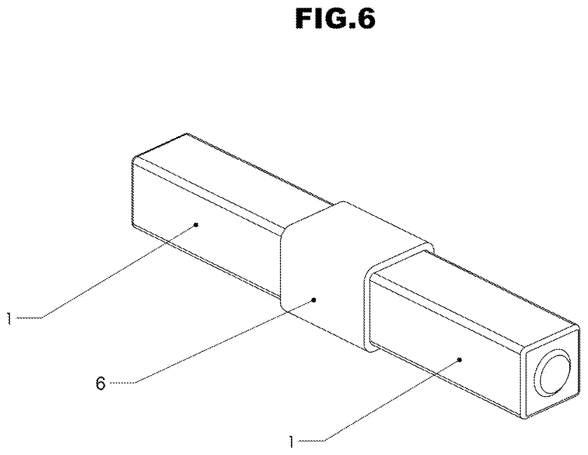

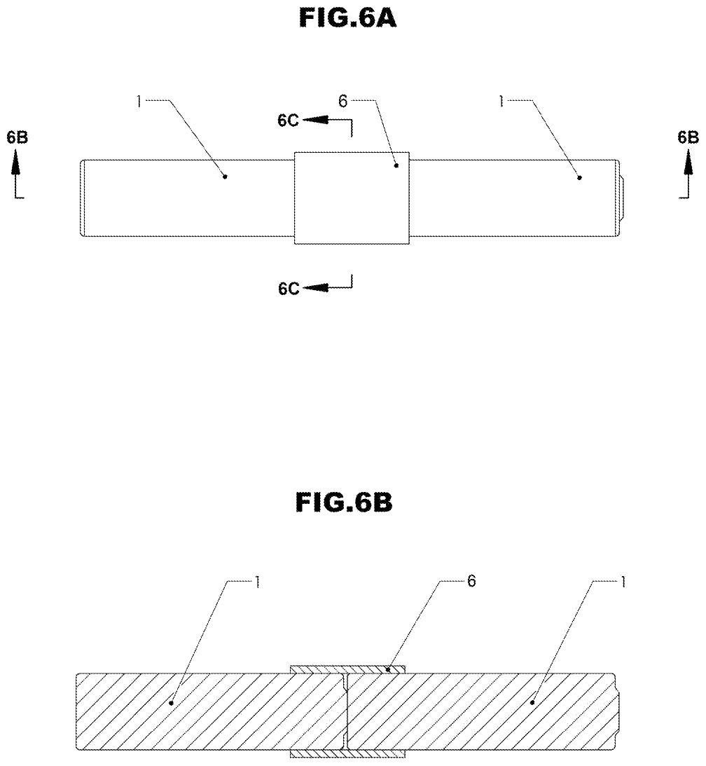

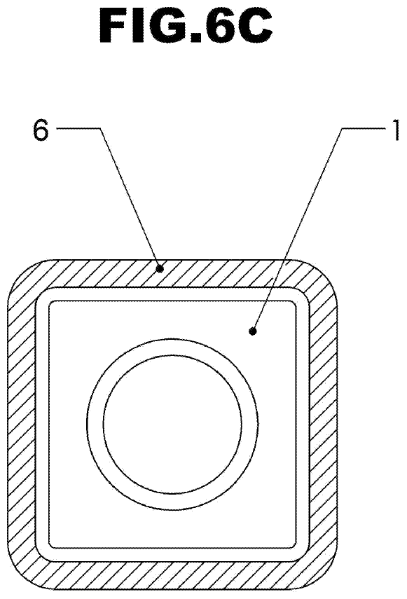

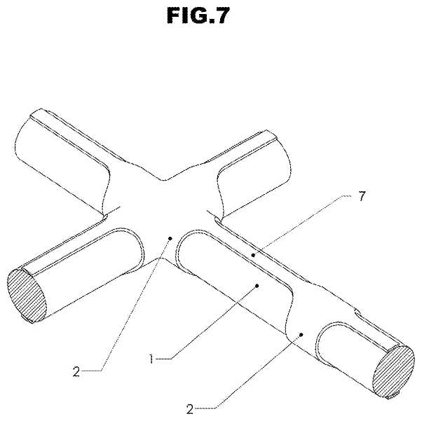

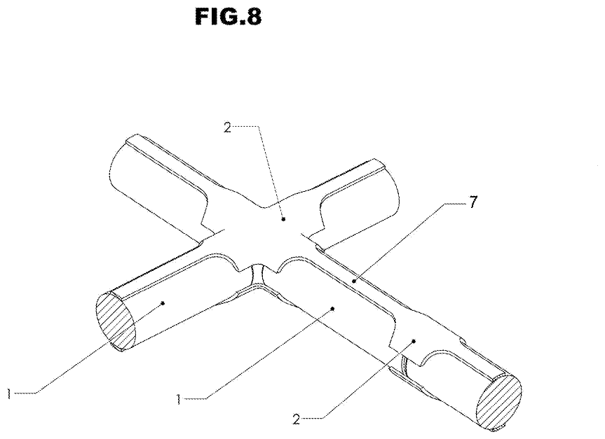

The load-bearing links (2) may connect two or more cells (1), as seen in FIG. 2. A load-bearing link may be in a form of a tube (3), as seen in FIG. 3, FIG. 3A, FIG. 3B, FIG. 3C, a sector of a tube (4), as seen in FIG. 4, FIG. 4A, FIG. 4B, FIG. 4C, two or more sectors of a tube (5), as seen in FIG. 5, FIG. 5A, FIG. 5B, FIG. 5C, the tubes, and their sectors may be circular or non-circular (6) as seen in FIG. 6, FIG. 6A, FIG. 6B, FIG. 6C. A load-bearing link may be in a form of a flat bar, a few flat bars, or various other complex forms. As seen in FIG. 7 and FIG. 8, there may be connecting elements between the links (7), combining two or more load-bearing links into a single structure. The connections may bear a part of the mechanical load on the structure.

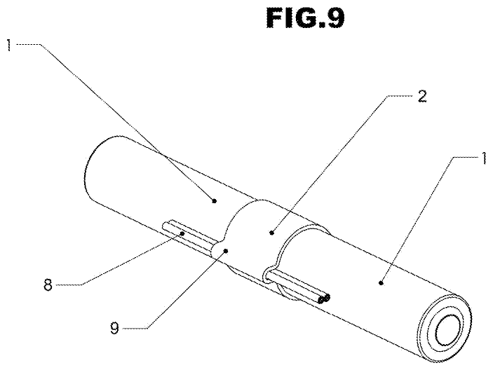

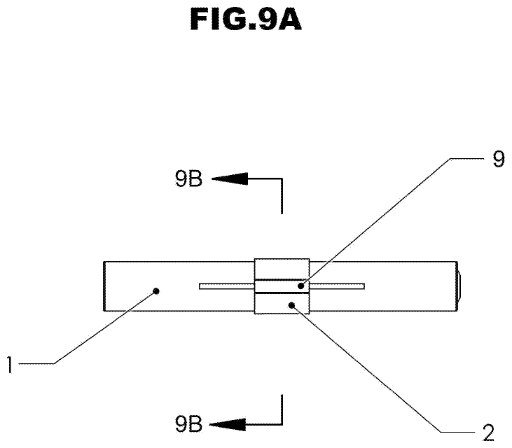

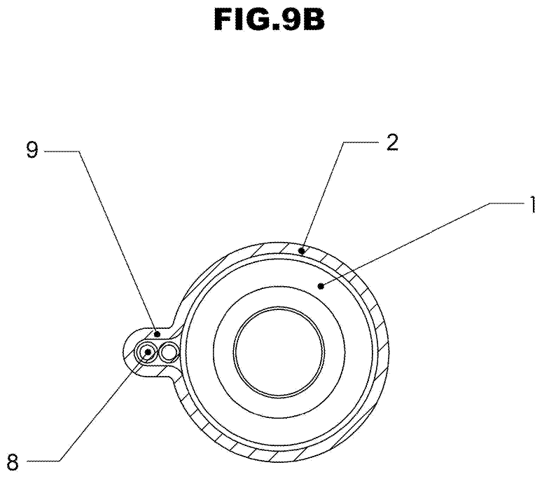

In various embodiments of the present invention, a load-bearing link (2) may have one or more channels (9) for wires (8) or other elements, as seen in FIG. 9, FIG. 9A, FIG. 9B.

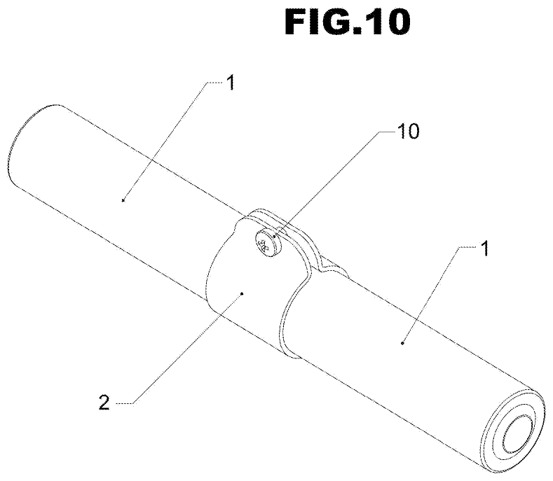

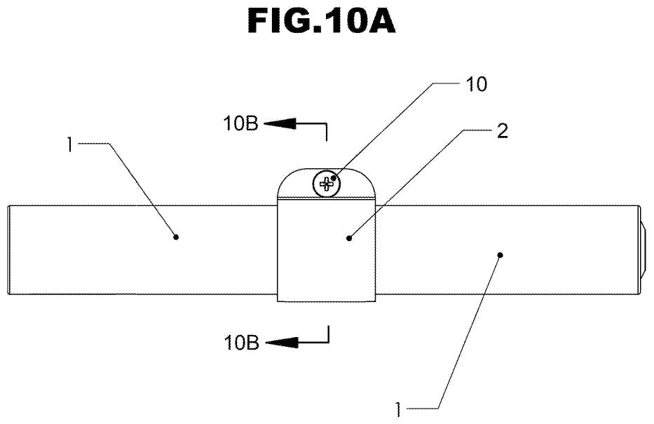

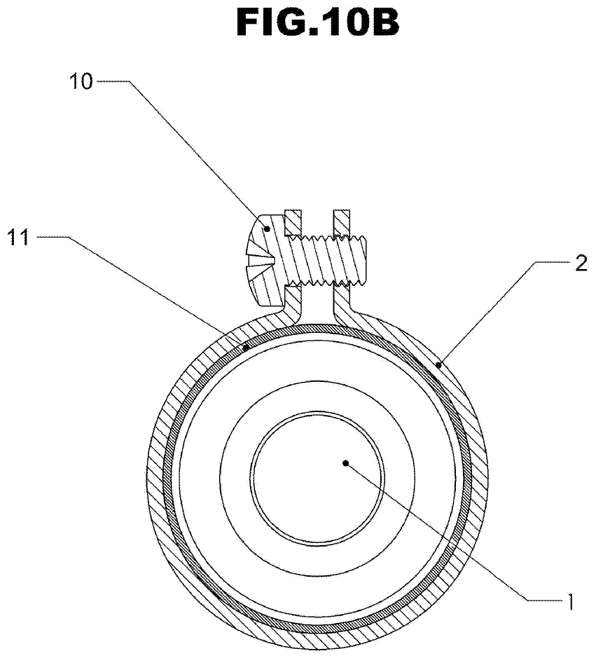

In various embodiments of the present invention, a load-bearing link (2), as seen in FIG. 10, FIG. 10A, FIG. 10B, may have one or more screws (10), or other tightening devices to mechanically clamp the link to a cell or cells (1).

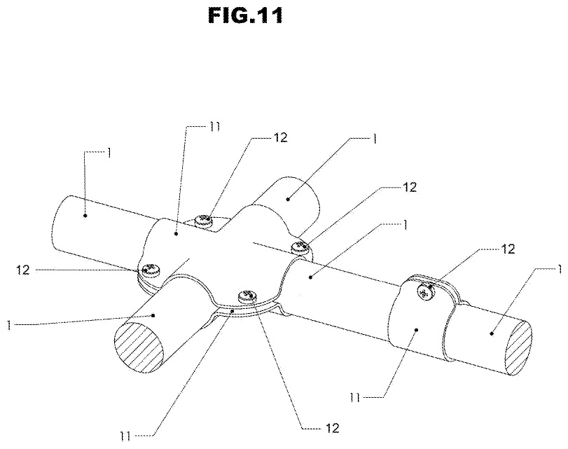

In various embodiments of the present invention, a load-bearing link, comprised of two or more elements (11), as seen in FIG. 11, may have one or more screws (12) to connect the elements to each other and mechanically clamp the link to a cell or cells (1), by sandwiching the cells between the elements

In various embodiments of the present invention, a load-bearing link may include a hinge or a slider, or a combination of these to allow relative movement of the load-bearing cells.

The load-bearing links may be attached to the cells by means of welding, or gluing, or soldering, or mechanical attachment, or any combination of these, or by any other way.

In various embodiments of the present invention, the load-bearing links may be electrically non-conductive.

In various embodiments of the present invention, the load-bearing links may be electrically conductive or may include one or more electrically conductive elements to connect the cells in parallel or in series or to provide an electrical connection to the battery or individual cells.

In various embodiments of the present invention, an electrical insulator (11) may be added between a load-bearing link and a load-bearing cell, as seen in FIG. 10B.

The load-bearing links may be made of plastic, metal, wood, composite materials, or any other materials capable of transferring mechanical loads between cells.

An exemplary aircraft of the present invention comprises, consists of, or consists essentially of a load-bearing structure including one or few load-bearing batteries. For example, the aircraft can be a multirotor aircraft with arms made of individual load-bearing batteries or one load-bearing battery forming the aircraft structure, as seen in FIG. 1.

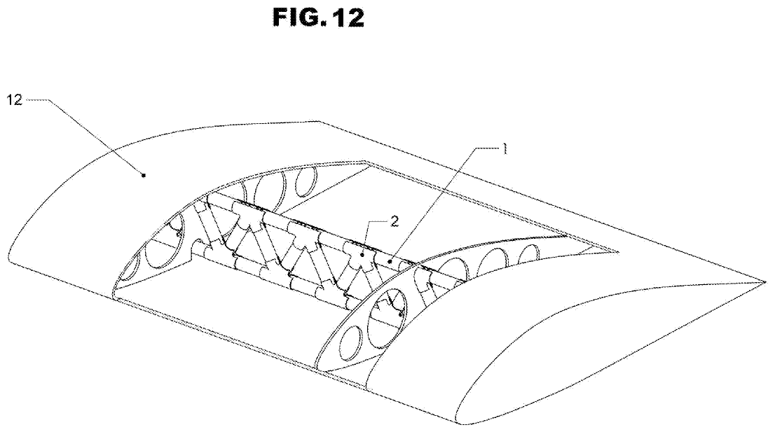

An aircraft load-bearing battery structure may be used as various other structural elements of an aircraft. An exemplary wing, as seen in FIG. 12, consists of a load-bearing battery as a wing spar (12) or other load-bearing element of a wing.

As seen in FIG. 12 the load-bearing structures may be made in a form of truss structures. The load-bearing structures may also be made in a form of spatial structures

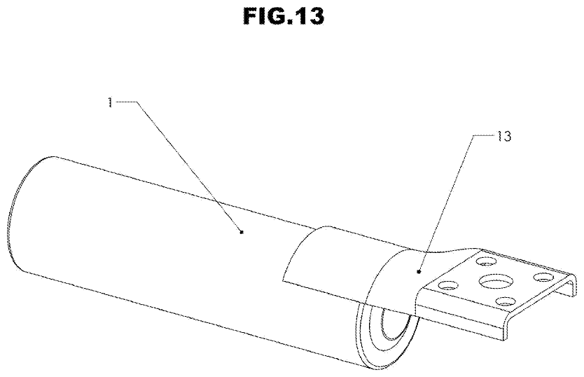

In various embodiments of the present invention, motor connectors (13), as seen in FIG. 13, may be used to mount a multirotor aircraft motor to the battery. The motor connectors transfer loads between cells (1) and the motors. The motor connectors may attach to the cells the same way and have the same features as described above load-bearing links.

What claimed is:

1. A mechanical load-bearing structure, comprised of electrochemical cells connected between each other and to other structures and elements with mechanical load-bearing links, where the cells transfer the mechanical load or a portion of the mechanical load between the links and the links transfer the mechanical load or a portion of the mechanical load between the cells and between the cells and other structures and elements.

2. The mechanical load-bearing structure of claim 1, wherein:
The load-bearing links between cells are in the form of a circular or non-circular tube, a sector of the tube, or two or more sectors of the tube, or in a complex form allowing them to securely attach to the cells.

3. The load-bearing links of claim 2, wherein:
The load-bearing links comprising one or more screws or other tightening devices adjusting the size of the links to clamp the links to the cells.

4. The load-bearing links of claim 2, wherein:
The load-bearing links comprising two or more elements that are connected to each other by screws that are tightened to securely clamp the cells by sandwiching the cells between the elements.

5. The load-bearing links of claim 2, wherein:
The load-bearing links comprise a channel for wires or other elements.

6. The load-bearing links of claim 2, wherein:
The load-bearing links comprising a hinge or a slider or a combination of these that allow relative movement of the load-bearing cells.

7. The load-bearing links of claim 2, wherein:
The load-bearing links comprise an electrical insulator between the cells and the link.

8. The load-bearing links of claim 2, wherein:
The load-bearing links are electrically conductive or include one or more electrically conductive elements and connect the cells in parallel, in series, or provide an electrical connection to the battery or individual cells.

9. The mechanical load-bearing structure of claim 1, wherein:
The load-bearing links are attached to the cells by means of welding, or gluing, or soldering, or mechanical attachment, or any combination of these.

10. The mechanical load-bearing structure of claim 1, wherein:
The load-bearing links are connected to each other with connecting elements combining the links into a single structure.

11. A multirotor aircraft comprising the mechanical load-bearing structure of claim 1 as a structural frame or part of a structural frame.

12. A wing comprising the mechanical load-bearing structure of claim 1 as a spar or a different load-bearing element.
